(19) United States
(12) Patent Application Publication
(10) Pub. No.: US 2013/0305512 A1
(43) Pub. Date: Nov. 21, 2013

(54) APPARATUS AND METHODS FOR FORMING MEDICAL DEVICES

(71) Applicant: Michael Green, Pleasanton, CA (US)

(72) Inventor: Michael Green, Pleasanton, CA (US)

(73) Assignee: ABBOTT CARDIOVASCULAR SYSTEMS, INC., Santa Clara, CA (US)

(21) Appl. No.: 13/475,769

(22) Filed: May 18, 2012

(51) Int. Cl. B21D 39/08; B23P 11/00

(52) U.S. Cl. 29/428; 72/393; 72/370.06

(57) ABSTRACT

A stent is mounted upon a tubular braid. A tapered mandrel is placed within the inner lumen of the braid to allow the stent to be expanded to a larger diameter. The tubular braid acts as a transport that reduces friction between the stent and the mandrel to help uniformly stretch the stent circumferentially. Uniquely shaped expansion mandrels limit the stresses applied to stent struts while the stent is expanded to a larger diameter. A plurality of longitudinally extending expansion blades cooperates to form a complete mandrel body. The expansion blades lie adjacent to one another and are capable of independently moving relative to each other in a longitudinal direction. Subsets of alternating expansion blades can be moved axially relative to the other subsets. The expandable mandrel may include numerous regions having progressively larger diameters than an adjacent region.

### BACKGROUND OF THE INVENTION

Briefly and in general terms, the present invention is directed towards a stent expanding device, often referred to as an expandable mandrel, and methods for expanding the dimensions of stents. The present invention also helps to reduce stress in the processing steps during the manufacturing of a stent.

The term stent generally refers to a prosthesis, which can be introduced into a corporeal lumen and expanded to support that lumen or attach a conduit to the inner surface of that lumen. Stents made of shape settable material are generally known in the art. Stents are generally either balloon expandable or self-expanding devices. A balloon expandable stent is delivered within the patient's vasculature mounted on a balloon catheter and can be expanded at an interventional site to accomplish implantation. A self-expanding stent is compressed into a reduced size having an outer diameter substantially smaller than the stent in its expanded shape. The stent is usually held in its compressed state by a restraining sheath during its passage through the patient's vascular system until reaching the target treatment site, whereupon the restraining sheath can be retracted to allow the compressed self-expanding stent to move into its deployed condition. Once in place, the radial struts of the stent bear against the inside walls of the passageway, thereby allowing normal blood flow.

One particular type class of shape settable materials that are practical for stents include Nickel-Titanium alloys (Nitinol). Previous methods to set a desired expanded Nitinol stent configuration involved forcing the stent over a cylindrical mandrel matching the desired inner diameter of the stent. The stent is then heat treated until the shape memory of the stent in its austenite phase has a diameter matching that of the mandrel. This process results in producing a stent that does not store stress in an optimal manner. Certain current approaches to stent expansion processes utilize the superelastic properties of Nitinol by creating a phase transformation in the stent as its diameter is enlarged. Alternatively, the stent may be tapered and, for example, transition from a seven millimeter (mm) diameter to a ten mm diameter over a thirty mm or forty mm length. Likewise, as with the uniform diameter stent, previous methods employed to expand a stent into a tapered stent involved forcing the stent onto a tapered mandrel and heating. Such methods suffer similar drawbacks to the methods used to uniformly expand stents.

During the expansion process, the mechanical stress in the Nitinol causes a phase transformation from austenite to martensite to accomplish a change in diameter. Stents may be chilled to lower temperatures to transform them to martensite as a way to lower the forces required by an operator to perform the expansion process. Once the stent has been shaped to the increased diameter, a heat treatment process is used to transform the atomic structure of the stent back to austenite and relieve built up internal stresses.

A variety of methods and systems are known for manufacturing stents, and for imparting a desired geometry onto the stent structure. Conventional methods of manufacturing stents required the expansion of the stents from a smaller diameter, or “as cut” position, to a larger diameter corresponding to the stent configuration as deployed in the patient. This expansion is typically performed by the intricate process of providing an initial heat treatment stage followed by the forcible sliding of the stents over a mandrel, and providing a subsequent heat treatment stage.

Some current expansion tooling consists of a cylindrical mandrel with a tapered end. In order to perform shape setting, an operator may use a push-pull technique to load the stent over the tapered mandrel. The superelastic property of Nitinol allows it to recover from up to eight to ten percent strain without deformation. The theoretical plane strain of a stent strut is up to six percent for practical expansions steps, when considering ideal radial expansion only. Additional strain provided by this technique may result in an amount of strain which exceeds the capability of the material to recover without deformation. Such a result is also associated with stents formed from materials which are not inherently superelastic. Inspection is required to determine whether further processing is needed to overcome the effects of this deformation.

Previous methods employed successive one to two millimeter expansions of stents by employing mandrels of successively larger diameters. Though so intended, these methods did not eliminate the presence of cracks and notch defects. Notch defects occur after the post expansion treatment of a cracked stent. Moreover, processing of the cut stent to an acceptable clinical size while retaining proper geometry is heavily influenced by the operator processing the stent.

Such conventional methods and systems generally have been considered satisfactory for their intended purpose. Recently, however, there is a need to reduce or eliminate the stress induced on the stent during application of the axial force required to forcibly slide the stent over the mandrel. The stresses generated within the stent material as the stent encounters radial loads and axial loads while being placed onto the mandrels can result in localized deformities such as strut fracture, kink, and flare. The presence of such deformities can jeopardize the structural integrity and performance characteristics of the stent. Further, such deformities can damage tissue in the lumen wall of the patient. Consequently, the conventional methods for expanding stents require extensive quality control and results in low product yield.

Additionally, the prior art method of expanding stents is disadvantageous in that the process must be performed in various discrete stages requiring numerous mandrels of differing sizes to provide incremental expansion in order to avoid damaging the stent. In many instances the requisite tooling and discrete process steps will reach a level that is too burdensome and complex to be performed in a cost effective manner. Examples of such prior art expansion techniques are disclosed in U.S. Pat. No. 6,305,436 and U.S. Pat. No. 6,402,779, each of which is hereby incorporated by reference in their entirety.

Expansion of stents from as cut to a proper clinical size while retaining proper geometry is currently heavily operator influenced. The process often requires numerous steps which can be tedious to the operator.

As evident from the related art, conventional methods often provide inadequate stent expansion techniques and cost prohibitive systems. There remains a need for an efficient and economic method and system to provide for stepwise expansion of shape memory stents, while reducing the overall stresses that the stent encounters, and thereby improving manufacturing yields due to fractured struts during expansion. Such a technique should limit the strain of individual struts to a minimal level while eliminating the presence of longitudinal forces on the stent during the process of loading the stent onto shape setting tooling. A device and method for reducing operator influence also would be beneficial. An improved method is desired that will also reduce the number of steps and will expand the stent is a more automated fashion. The present invention satisfies these and other needs.

### SUMMARY OF THE INVENTION

In accordance with the purpose of the invention, as embodied and broadly described, the invention includes a method of manufacturing a medical device comprising forming a stent having an internal lumen, a proximal end, a distal end, and a longitudinal axis extending therebetween, the stent having a generally cylindrical shape defining a first stent diameter. In one aspect of the present invention, an expandable tubular braid is initially inserted into either the proximal or distal end of the stent, with the expandable tubular braid extending along the longitudinal axis of the stent and having a first expansion diameter. This stent can be radially expanded to a second stent diameter when radial force exerted by an expandable mandrel, or other expansion device, is placed into the internal lumen of the tubular braid to expand the stent to a second, larger stent diameter. This expandable tubular braid provides a sliding surface which provides a transport that reduces the amount of friction that would otherwise be present as the stent slides over the mandrel. This allows the stent to be more easily moved along the expanding diameter of the mandrel to help to uniformly stretch the stent circumferentially as it moves axially along the mandrel. The expandable tubular braid can be made from materials, such as, but not limited to, stainless steel, quartz and other high temperature materials, which can be chilled and heated along with the stent. Accordingly, the expandable tubular braid also allows the expanded stent to be easily removed from the mandrel.

In another aspect, the invention provides uniquely shaped expansion mandrels which limit the stresses applied to stent struts during the expansion process of manufacturing stents. Particularly, the expandable mandrel is made with a plurality of longitudinally extending expansion blades which cooperate to form a complete mandrel body. The expansion blades lie adjacent to one another and are capable of independently moving relative to each other in a longitudinal or axial direction. Subsets of alternating expansion blades can be moved axially relative to the other subsets. In this regard, expandable blade subsets can be moved axially to receive the stent. The expandable mandrel can be made with numerous regions having progressively larger diameters than an adjacent region. Once the stent is placed on one of the blade subsets, the stent can be progressively moved along the length of the mandrel by progressively moving the expandable blade subsets. In this regard, the mandrel changes its profile as blade subsets are axially moved to produce the desired expanded diameter for the stent. In this fashion, the stent can be incrementally “walked’ along the lengths of the expandable blades to progressively increase the stent diameter into the desired final expanded diameter. The structure of the expandable mandrel allows the stent to be progressively expanded to a larger diameter without compromising the integrity of the stent structure. Accordingly, the often thin struts of the stent should be less susceptible of breakage when a progressive increase of the stent's diameter is obtained.

In one particular aspect of the present invention, expansion blades are arranged to provide a “walking beam” type of motion which is transferred to the mounted stent. In this particular aspect, each expansion blade is mounted within a blade holder which allows the blades to slide longitudinally or axially therein. One sequence of moving causes a first subset of blades to move upward and radially outward causing the mounted stent to expand somewhat. the subset of blades are then moved linearly to another position, while the blades are still in the outright position, to allow the stent to make contact with another subset of expansion blades which receives the now expanded stent. The second subset of blades move in a similar fashion to again expand radially outward to an expanded position which again further expands the stent. The second subset of blades then move linearly to cause the further expanded stent to make contact with the first subset of blades, albeit, that the stent contact with the first subset of blades is at a region on the first subset which has a progressively larger diameter from the position where the stent was initially mounted on the first set of blades. A motor or other actuator could be coupled to the first and second blades to achieve this walking beam” type of motion.

The methods of the present invention provide for the stepwise expansion of shape memory stents, which reduce the overall stresses that the stent encounters, and thereby improving manufacturing yields by reducing the number of fractured struts which can result during stent expansion.

The above described devices and methods have broad applicability to stents made of any shape settable material. Other features and advantages of the present invention will become apparent from the following detailed description, taken in conjunction with the accompanying drawings, which illustrate, by way of example, the principles of the invention.

### BRIEF DESCRIPTION OF THE DRAWINGS

FIG. 1 is a perspective view depicting a stent, mandrel and an expandable tubular braid used in accordance with the present invention.

FIG. 2 is a perspective view showing the expandable tubular braid of FIG. 1 placed within the inner lumen of the stent.

FIG. 3 is a perspective view depicting the stent and expandable tubular braid of FIG. 2 placed on the mandrel.

FIG. 4 is a perspective view depicting an embodiment of an expandable mandrel made in accordance with the present invention.

FIG. 5 is a perspective view depicting a particular embodiment of an expandable blade which forms part of the expandable mandrel of FIG. 4.

FIG. 6 is a perspective view depicting the subsets of expandable blade which make up the expandable mandrel of FIG. 4.

FIG. 7 is an end view of the expandable mandrel of FIG. 4.

FIG. 8 is a perspective view of another embodiment of an expandable mandrel made in accordance with the present invention.

FIG. 9 is an end view of the expandable mandrel of FIG. 8.

FIG. 10 is a perspective view depicting another embodiment of an expandable mandrel made in accordance with the present invention.

FIG. 11 is an end view of the expandable mandrel of FIG. 10

FIG. 12 is a perspective view depicting another embodiment of an expandable mandrel made in accordance with the present invention.

FIG. 13 is an end view of the expandable mandrel of FIG. 12.

FIG. 14 is a perspective view depicting another embodiment of an expandable mandrel made in accordance with the present invention.

FIG. 15A is a perspective view depicting the expandable mandrel of FIG. 14 with a stent mounted thereon.

FIG. 15B is an end view of the expandable mandrel shown in FIG. 15A with the stent mounted thereon.

FIG. 16A is a side view showing a blade A of the expandable mandrel of FIG. 14 in a first position and a second adjacent blade B (shown with phantom lines) in an adjacent position which depicts the motion and positioning between blades that move stent along the length of the expandable mandrel.

FIG. 16B is an end view of the expandable mandrel shown in FIG. 15A with the stent mounted thereon with alternation blades arranged in the positions depicted in FIG. 16A.

FIG. 17 is a side view of blade A and blade B of FIG. 16A as the blades move relative to each other to move the stent along the length of the expandable mandrel.

FIG. 18 is a side view showing the progression of movement of blades A and B of FIGS. 16A and 17 as the blades move relative to each other which results in the stent moving along the length of the expandable mandrel.

FIG. 19 is a side view showing the progression of movement of the blade A and B of FIGS. 16A, 17 and 18 as the blades move relative to each other to effect the movement of the stent along the length of the expandable mandrel.

FIG. 20 is a side view showing the progression of movement of the blade in FIGS. 16A and 17-19 as the blades A and B progressively move the stent along the length of the expandable mandrel.

### DETAILED DESCRIPTION OF THE PREFERRED EMBODIMENTS

Turning now to the figures, which are provided for example and not by way of limitation, there is shown an expandable tubular braid and expandable mandrel made in accordance with the present invention. These devices are appropriate for both open cell and closed cell stents. The methods and systems presented herein may be used for imparting a desired shape or contour to a medical endoprosthesis such as a stent. The invention is particularly suited for expanding a stent using a tapered or stepped mandrel which reduces the stresses that are generated due to axial loads applied to the stent as the stent is being loaded onto the mandrel. For purpose of explanation and illustration, and not limitation, an exemplary embodiment of the system in accordance with the invention is illustrated in the accompanying Figures.

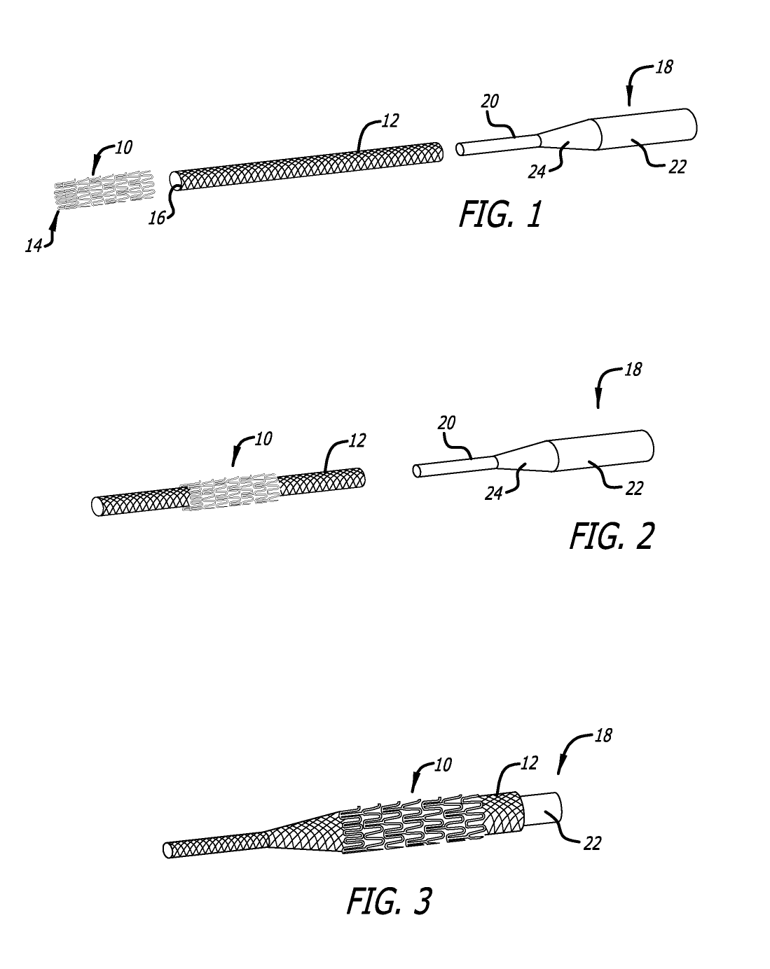

FIG. 1 illustrates an example of a stent 10 formed from a plurality of rings which can be expanded to a desired set diameter in accordance with the invention. These rings are radially expandable and interconnected by connecting members that are disposed between and connect adjacent struts rings. Openings or gaps are generally formed between the rings and connecting members. These rings and connecting members are usually referred to a strut. The struts of stents can be manufactured in any number of patterns, especially intricate patterns which are quite flexible. As a result, some stents are formed with struts having very small widths and/or thicknesses. Unfortunately, as the struts get thinner in width and/or thickness, they are more susceptible to fracture during the manufacturing process. The particular geometry of the struts depicted in the drawings is merely for purpose of explanation. Various stent geometries and configurations such as stents having differing structural properties, variable flexibility, variable radiopacity, as well as various categories of stents (i.e., balloon expandable, self-expanding and drug eluting stents) are contemplated to be within the scope of the present invention.

The stents formed in accordance with the invention are preferably made from a shape memory material such as Nitinol (Ni—Ti alloy). In manufacturing the Nitinol stent, the material is first in the form of a tube. Nitinol tubing is commercially available from a number of suppliers. The tubular member is then loaded into a machine that will cut the predetermined pattern of the stent into the tube. Machines for cutting patterns in tubular devices to make stents or the like are well known to those of ordinary skill in the art and are commercially available. Such machines typically hold the metal tube between the open ends while a cutting laser, preferably under microprocessor control, cuts the pattern. The pattern dimensions and styles, laser positioning requirements, and other information are programmed into a microprocessor, which controls all aspects of the process. After the stent pattern is cut, the stent is treated and polished using any number of methods or combination of methods well known to those skilled in the art.

In one embodiment of the invention, an expandable tubular braided sleeve 12 is initially inserted within the internal lumen 14 of the stent 10, as shown in FIG. 2. In some applications, the initial diameter of the expandable braided sleeve 12 is approximately equal to the initial inner diameter of the stent 10 so as to provide an interference fit between the stent and the expandable braided sleeve 12. Further, the exterior surface of the expandable braided sleeve 12 can be coated with a lubricious layer or film to facilitate the insertion of the sleeve into the inner lumen 14 of the stent 10. Alternatively, the initial outer diameter of the braided sleeve 12 may be slightly less than the initial inner diameter of the stent 10 to allow for rapid insertion of the braided sleeve 12 into the stent 10.

The braided sleeve 12 includes an internal lumen 16 as well. In use, the braided sleeve 12 is inserted into either the proximal or distal end of the stent 10, with the braided sleeve 12 extending along the longitudinal axis of the stent 10 and having an initial unexpanded diameter. The initial unexpanded diameter of the braided sleeve 12 allows the braided sleeve 12 to be placed over a mandrel 18. The mandrel 18 includes a first expansion portion 20 having a constant first diameter over its length to form a tubular structure. The mandrel 18 further includes a second expansion portion 22 having a second constant diameter which also forms a tubular structure. The second diameter of the second expansion portion 22 is larger than the first diameter of the first expansion portion 20. These first and second portions 20 and 22 are coupled by a tapered portion 24 having a tapering outer diameter which starts initially at the first diameter of the first expansion portion 20 and gradually increases to the second diameter of the second expansion portion 22. In an alternative design, this portion 24 could be non-tapered.

As can be seen in FIGS. 1-3, the braided sleeve 12 is initially inserted into the lumen of the stent 10. The stent and braided sleeve 12 can then be placed on the first expansion portion 20 of the mandrel 18. Since the first expansion portion 20 has a smaller overall diameter, there is little or no application of an outward radial force on the braided sleeve 12 and stent 10. The braided sleeve 12 and stent 10 are then manipulated by the operator along the length of the mandrel 18. Initially, the stent 10 and braided sleeve 12 travel along the tapered portion 24 where some radial forces will be applied to both the stent 10 and the braided sleeve 12. Since the mandrel 18 is tapered at this portion 24, the radial force progressively gets larger as the stent 10 and braided sleeve 12 are moved towards the second expansion portion 22. Accordingly, both the diameter of the stent 10 and the braided sleeve 12 will progressively increase.

The operator will now move the braided sleeve 12 and stent to the second expansion position 22 where the mandrel 18 is at its maximum diameter. Here, the stent 10 and braided sleeve 12 will achieve their maximum diameters.

As discussed above, the stents preferred embodiment of the invention are made from Nitinol. The shape memory characteristics of such a Nitinol stent allow the stent to be deformed to facilitate their insertion into a body lumen or cavity and then be heated within the body so that the device returns to its original shape. Superelastic characteristics, on the other hand, generally allow the metal to be deformed and restrained in the deformed condition to facilitate the insertion of the medical device containing the metal into a patient's body, with such deformation causing the phase transformation. Once within the body lumen, the restraint on the superelastic member can be removed, thereby reducing the stress therein so that the superelastic member can return to its original un-deformed shape by the transformation back to the original phase.

Alloys having shape memory/superelastic characteristics generally have at least two phases. These phases are a martensite phase, which has a relatively low tensile strength and which is stable at relatively low temperatures, and an austenite phase, which has a relatively high tensile strength and which is stable at temperatures higher than the martensite phase.

The shape memory characteristics of the invention described above are preferably imparted to the alloy under a controlled temperature environment. This temperature control serves to make the stents more ductile during the expansion process. The increase in material ductility can be achieved while exposing the stent to a temperature, for example, of approximately −40 degrees Fahrenheit. Additionally, the desired increase in material ductility can be achieved while exposing the stent to a temperature between approximately 175 and 600 degrees Fahrenheit. Consequently, the shape of the metal during this heat treatment is the shape “remembered.”

The stent 10 and braided sleeve 12 can be expanded at any operable temperature. For example, the stent 10 and braided sleeve 12 can be cooled, heated or placed at room temperature when being expanded by the mandrel 18. In one aspect, the operator can initially reduce the amount of force being applied to the stent 10 by placing the stent 10 and braided sleeve 12 in a temperature controlled environment or zone when the stent is initially placed on the first expansion portion 20 of the mandrel 18. The temperature of the ambient environment can be different depending upon the materials used to create the stent. For example, the stent 10, braided sleeve 12 and mandrel 18 could be immersed in alcohol to cool the stent 10 to approximately −10° C. when the stent is initially placed on the first expansion portion 20 of the mandrel 18. The cooling causes the Nitinol stent to transition to the martensite phase in order to reduce the forces exerted by the operator when moving the stent 10 and braided sleeve 12 along the various portions of the mandrel in order to enlarge the stent 10 to a second stent diameter. Thereafter, the stent 10 is in an expanded configuration. The stent 10 along with the braided sleeve 12 may also be heat treated (and cooled). This would allow the shape of the stent to be heat set into the stent. It is contemplated that not all stents require the same cooling or heating steps.

The use of the braided sleeve 12 allows the operator to connect the end of the braided sleeve to a mechanism which will move the stent 10 with braided sleeve along the length of the mandrel 18. Accordingly, the steps of treating the stent to expand the diameter can be implemented by a mechanism rather than by the hands of the operator. This allows prevents the need to subject the hands of the operator to the temperature controlled environment.

The braded sleeve 12 can be made from a number of materials, including, but not limited to, stainless steel, quartz and other high temperature materials. The use of such materials allows the braided sleeve 12 to be subjected to high or low temperatures during the stent enlarging process. These materials also allow the braided sleeve 12 to expand with the stent 10 as the stent 10 and braided sleeve 12 are moved along the length of the mandrel 18. These materials reduce the amount of friction that would be otherwise acting on the stent in the absence of the braided sleeve 12. Also, since the stent 10 can be made with highly fragile strut patterns, the braided sleeve acts as a suitable transport which moves the stent 10 the mandrel 18 with little risk of fracture.

The operation of inserting the mandrel into the stent can be accomplished by a myriad of manual or automatic apparatus designs. Obviously, the braided sleeve 12 could be manually advanced over the mandrel 18 by the hands of the operator. Other examples include an actuating mechanism which could be employed to provide axial motion to advance the mandrel 18 into the lumen of the braided sleeve 12. In this manner, the operator only needs to hold the braided sleeve 12 or he/she could clamp the braided sleeve 12 to a holding fixture. Additionally, various other types of mechanisms including pneumatics, hydraulics, or linear motors can be utilized to ensure that the motion of the mandrel occurs gradually and/or consistently to limit the production of stress spikes within the stent.

The stent 10 and braided sleeve 12 of FIGS. 1-3 are shown being processed on a particular sized and shaped mandrel 18 for purposes of disclosure. It should be understood that the braided sleeve 12 can be used any one of a number of mandrels that will expand the diameter of both the braided sleeve 12 and the stent 10. For example, the braided sleeve 12 could be used with the expansion mandrels disclosed below. Still other mandrels could be used with the stent/tubular braid setup disclosed herein.

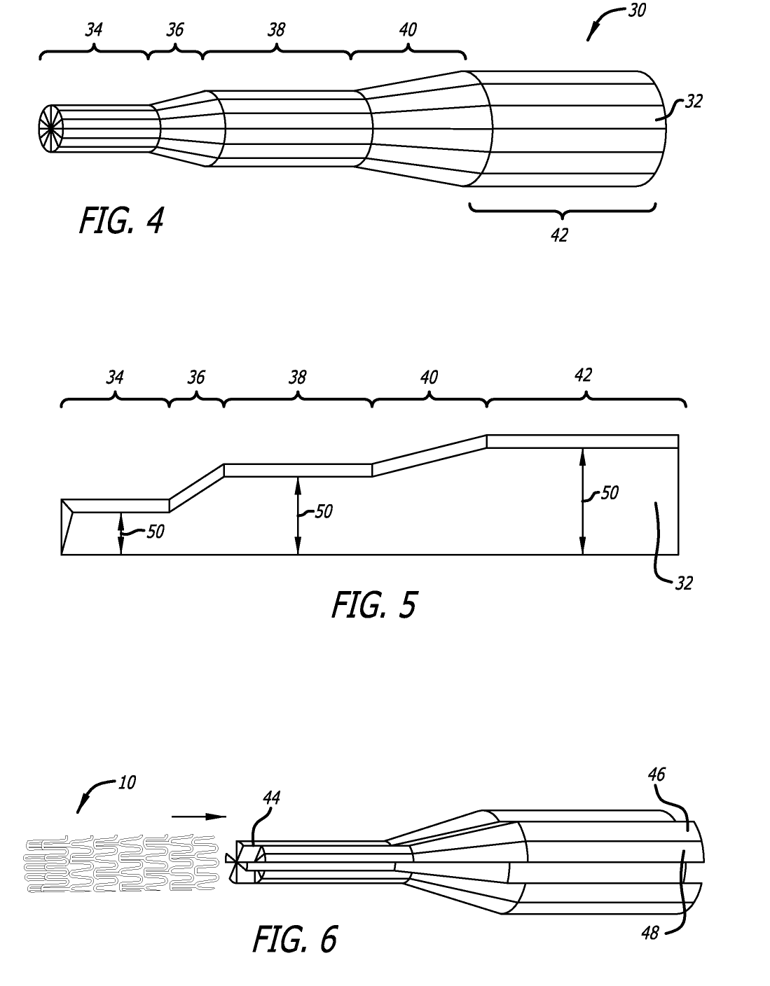

Referring now to FIGS. 4-13, various embodiments of an expandable mandrel made in accordance with the present invention are shown. Referring initially to FIGS. 4-7, one embodiment of an expandable mandrel 30 includes a number of expandable blades 32 which cooperate to form the composite mandrel 30. An individual expandable blade 32 is best shown in FIG. 5. Each expandable blade 32 is designed with a particular shape that creates expansion regions on the mandrel 30. For example, as can be seen in FIG. 4, the mandrel 32 includes a first expandable region 34 which has a substantially uniform diameter. This first region 34 transitions to a first tapered expandable region 36 which has a gradually increasing diameter as this tapered region 36 transitions to a second expandable region 38. This second expandable region has a diameter which is larger than the first region 34. A second tapered region 40 with a gradually increasing diameter in turn transitions to a third expandable region 42 which has a substantially uniform diameter. This third expandable region 42 has the largest diameter of the three expandable regions 34, 38 and 42.

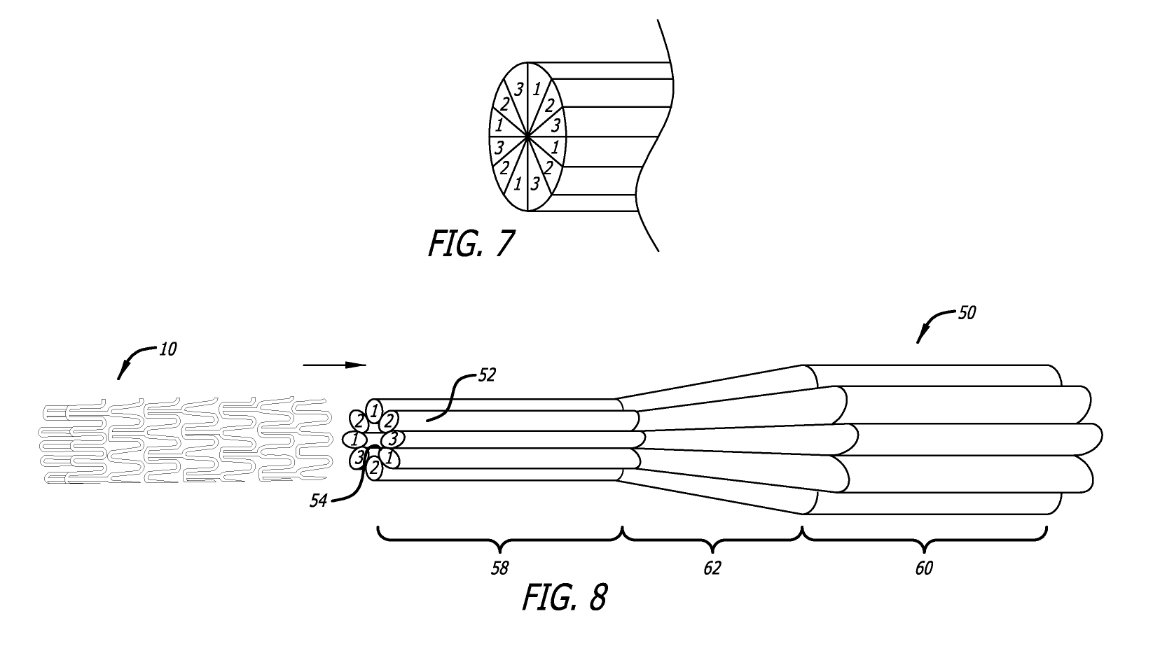

These longitudinally extending expansion blades 32 cooperate to form a complete mandrel body and lie adjacent to one another or, alternatively, could have space between them. These expansion blades also are capable of independently moving relative to each other in a longitudinal or axial direction. In this regard, one or more expansion blades can be advanced in front of the other expansion blades, as is shown in FIG. 6. In addition, subsets of alternating expansion blades 32 can be moved axially relative to the other subsets. In this regard, a subset of expansion blades 32 can be grouped to move longitudinally together relative to the other subsets. FIG. 6 shows one subset 44 of expansion blades 32 which are advanced in front of the other expansion blades 32. Here, the subset 44 of expandable blades 32 consist of four individual expansion blades 32 which can be moved as a single unit by the operator. This subset 44 can be moved axially to initially receive the stent. There are two other subsets 46 and 48 which complete the composite mandrel. The individual expansion blades making up subset 46 are denoted by the numeral 2 in FIG. 7 which shows the very end of the mandrel. The individual expansion blades 32 making up subset 48 are denoted by the numeral 3 in FIG. 7. The numeral 1 shows the expansion blades forming the first subset 44.

Once the stent is placed on one of the blade subsets, the stent can be progressively moved along the length of the mandrel by progressively moving the various subsets 44, 46 and 48 of expandable blades. In this regard, the mandrel changes its profile as the blade subsets 44, 46 and 48 are axially moved to produce the desired expanded diameter for the stent. In this fashion, the stent can be incrementally “walked” along the length of the expandable blades to the desired expansion region where the stent will be expanded to its final diameter.

The expandable mandrel can be made with numerous regions having progressively larger diameters than an adjacent region. This structure allows the stent to be progressively expanded to a larger diameter without compromising the integrity of the stent structure. Accordingly, the often thin struts of the stent will be less susceptible of breakage when a progressive increase of the stent's diameter is obtained.

As can be seen in FIGS. 4-7, each expandable blade has a “wedge” or “pie-shaped” cross sectional area. Accordingly, these wedge shaped areas, when combined together, help to create the cylindrical shaped expansion regions associated with the mandrel. FIG. 5 shows an individual expansion blade 32 which has a wedge or pie shape. As can be seen in FIG. 5, each expansion region is formed by selectively altering the “height” of the expansion blade 32. For example, the first expansion region 34 has the smallest diameter of all of the expansion regions. Accordingly, the blade 32 has the smallest height in this region. Arrows 50 are used to show the varying height along the length of the expansion blade 32. At the first tapered region 36, the height of the blade increase until it reaches the height at the second expansion region 38. Accordingly, the height of the various regions will reflect the final diameter obtained in the respective regions of the mandrel.

The subsets of expansion blades can be joined together utilizing connecting fixtures such as, for example, slip rings or other fastening devices which maintain the blades together to form the composite mandrel but which still allows the blades to move or slide relative to each other. The connecting fixtures could be attached at the ends of the mandrel. For example, the first subset 44 can be constructed such that the four individual expansion blades are connected together along the apex of the wedge shape to create a solid piece. The remaining subsets 46 and 48 can be slidingly attached along the length of the first subset 44 utilizing rings (not shown) at the ends of the blades 32 that connect the respective blades that form each subset 46 and 48. Still other fastening means could be used to maintain all of the expansion blades together.

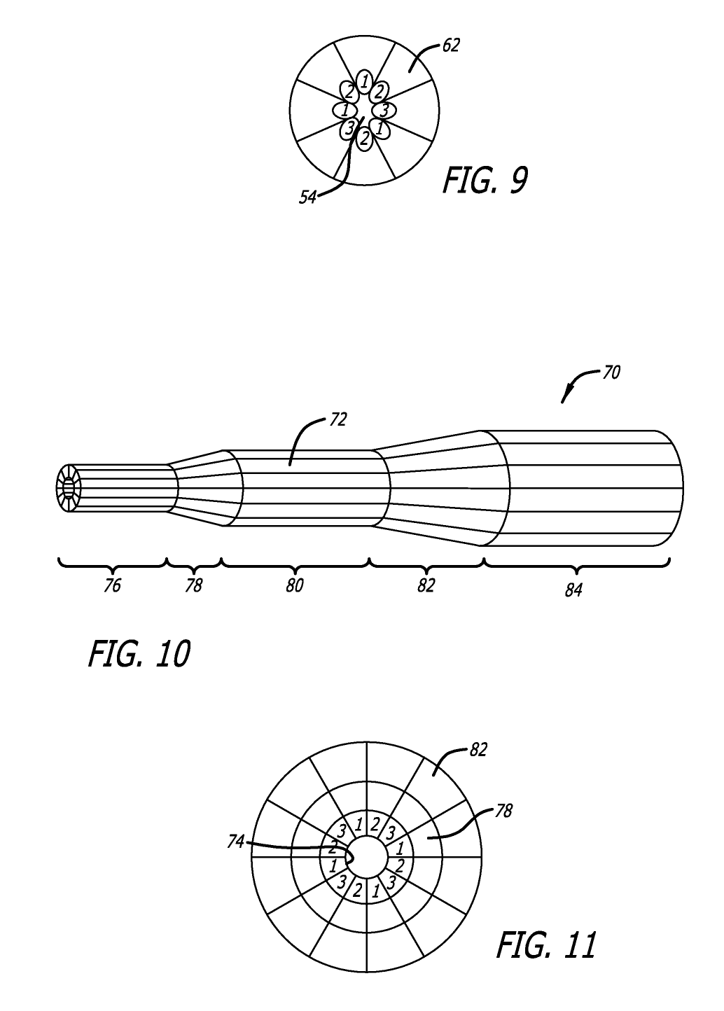

FIGS. 8-9 show another embodiment of an expansion mandrel 50 which utilizes the principles of the present invention. In this particular embodiment, each expansion blade 52 has a round cross sectional area, as opposed to the wedge or pie-shaped cross sectional area of the blade 32 shown in FIGS. 4-7. In this regard, the individual expansion blades 52 could be made from a wire or similar structure which creates a lumen 54 in the mandrel (see FIG. 9). These individual expansion blades 52 can be joined together in individual subsets, as described above, so that the stent can be progressively moved along the length of the mandrel 50 by progressively moving the various subsets of expandable blades 52. In this regard, the mandrel 50 changes its profile as the blade subsets are axially moved to produce the desired expanded diameter for the stent. In this fashion, the stent can be incrementally “walked” along the length of the expandable blades 52 to the desired expansion region where the stent will be expanded to its final diameter. The various subsets forming this particular mandrel are indicated by numerals 1, 2 and 3 in FIGS. 8 and 9. The mandrel 50 is shown having only two expansion regions 58 and 60 and a single tapered region 62. It should be appreciated that the mandrel of this embodiment, and all of the disclosed embodiments, can be made with a desired number of expansion regions and tapered regions. The particular invention shown in FIGS. 8-9 is not limited to only two expansion regions and one tapered region.

FIGS. 10-11 show yet another embodiment of an expansion mandrel 70 which utilizes the principles of the present invention. In this particular embodiment, each expansion blade 72 has a truncated pie-shaped cross sectional area, as opposed to the wedge or pie-shaped cross sectional area of the blade 32 shown in FIGS. 4-7 or the circular or oval shaped blade 52 shown in FIGS. 8-9. This embodiment of the mandrel 70 shows how the individual expansion blades 72 can be shaped to create a composite expansion mandrel. As with the other mandrel described above, these individual expansion blades 72 can be joined together in individual subsets so that the stent can be progressively moved along the length of the mandrel 70 by progressively moving the various subsets of expandable blades. In this regard, the mandrel 70 changes its profile as the blade subsets are axially moved to produce the desired expanded diameter for the stent. In this fashion, the stent can be incrementally “walked” along the length of the expandable blades 72 to the desired expansion region where the stent will be expanded to its final diameter. The various subsets forming this particular mandrel are indicated by numerals 1, 2 and 3 in FIGS. 10-11. The mandrel 70 is shown having three expansion regions 76, 80 and 84 and two tapered regions 78 and 82. Again, it should be appreciated that the mandrel of this embodiment, and all of the disclosed embodiments, can be made with a desired number of expansion regions and tapered regions. The particular invention shown in FIGS. 10-11 is not limited to number of expansion and tapered regions shown in the drawings.

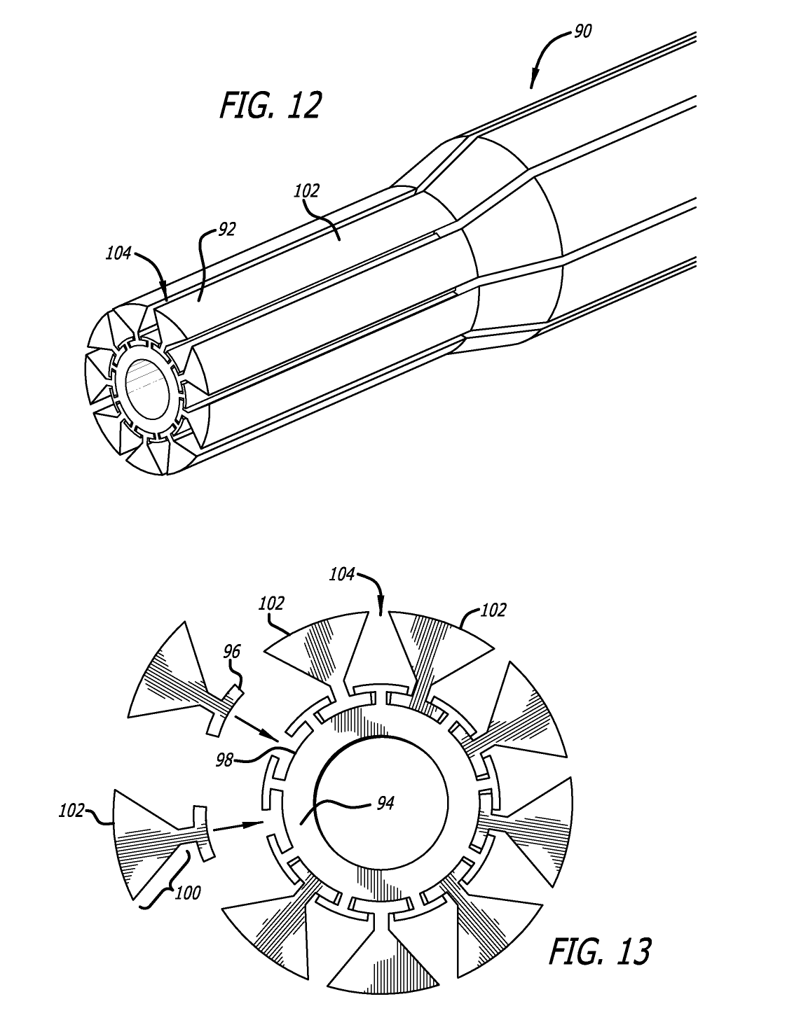

FIGS. 12-13 show another embodiment of an expansion mandrel 90 which utilizes the basic principles of the present invention. In this particular embodiment, each expansion blade 92 is mounted to a blade holder 94 which allows the blades 92 to slide longitudinally or axially therein. As can be seen in these figures, each expansion blade 92 has a T-shaped edge 96 running along its length which is adapted to fit within the slot 98 formed on the blade holder 94. The blade holder 94 with its formed slots 98 can extend along the entire length of the expansion blade 92 or can extend partially along the length of the blades 92. As can be seen in FIG. 13, each expansion blade 92 has an expanded region 100 which forms the various tapered and expansion regions of the mandrel. As is specifically shown in FIG. 13, the outer surfaces 102 of the adjacent blades do not have to contact each other in order to form the various regions of the mandrel. The formation of a space 104 between adjacent blades 92 still allows the individual expansion blades 92 to form generally cylindrical expansion regions on the mandrel. It should be appreciated that the shape of the slots 98 of the blade holder 94 can be varied, along with the shaped of the edge 96 of the individual expansion blades 92 to form the composite mandrel 90. As with the other embodiments, these individual expansion blades 92 can be joined together in individual subsets, as described above, so that the stent can be progressively moved along the length of the mandrel by progressively moving the various subsets of expandable blades. The mandrel 90 can have a desired number of expansion regions and tapered regions.

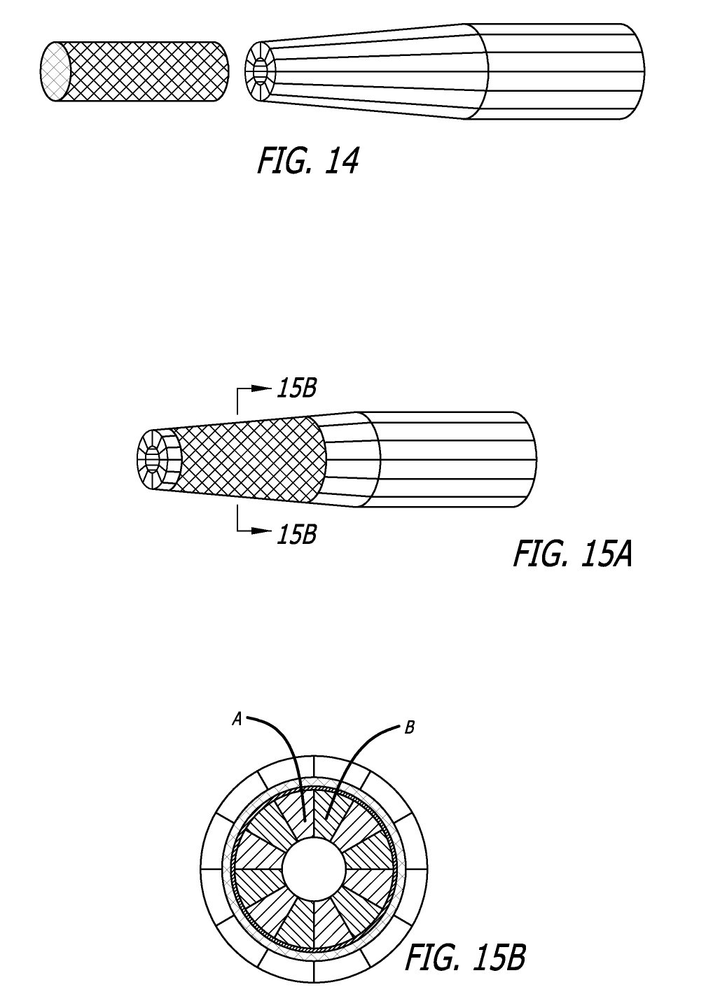

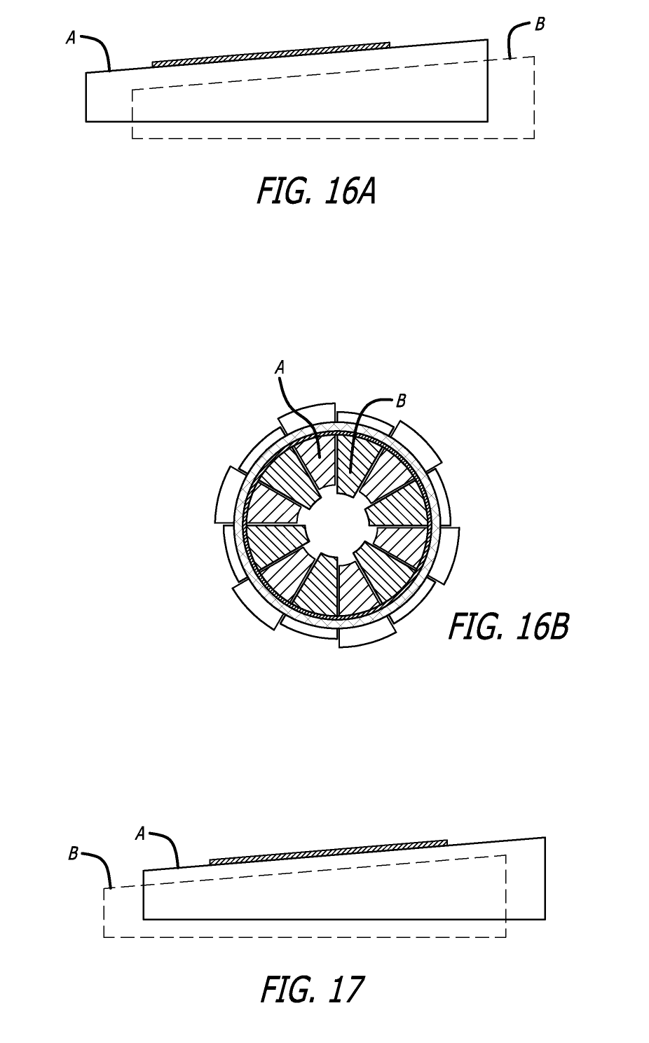

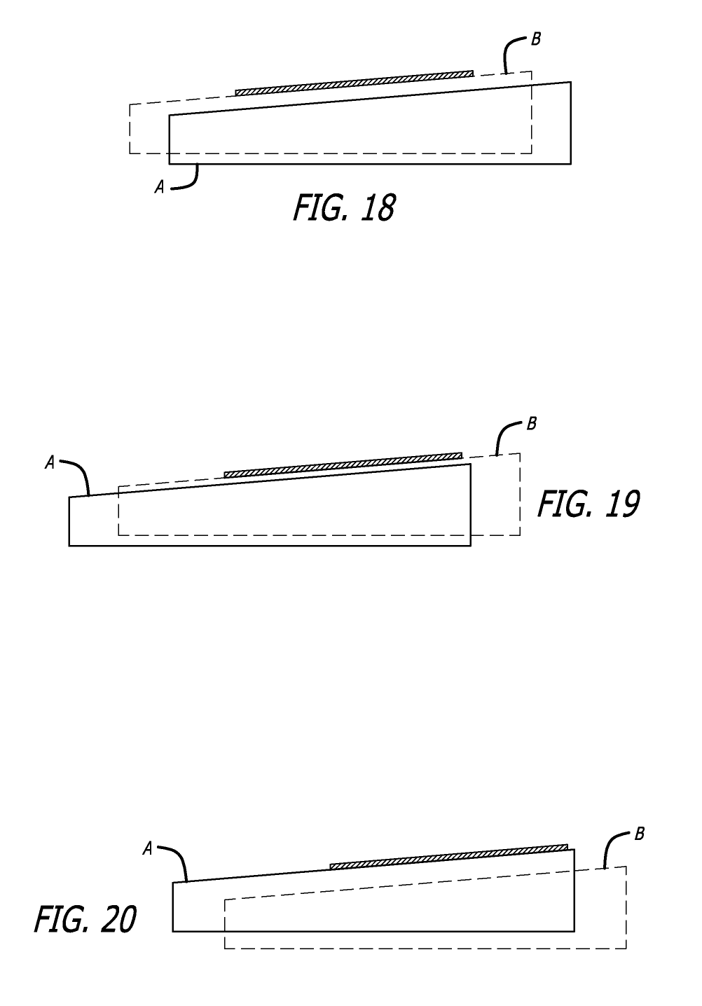

FIGS. 14-20 show another embodiment of an expansion mandrel 110 which utilizes the basic principles of the present invention, except the blades 112 are arranged to provide a “walking beam” type of motion which is transferred to the mounted stent 114. In this particular embodiment, each expansion blade 112 is mounted within a blade holder (not shown) which allows the blades 112 to slide longitudinally or axially therein. As can be seen in FIGS. 16A and 17-20, one sequence of moving a pair of expansion blades A and B is shown to illustrate how the relative movement of these blades A and B progressively move the stent along the length of the expansion mandrel to achieve the desired setting of the diameter of the stent 114. The sequence of blade movement shown in FIGS. 16A and 17-20 create an automated walking beam type of device which progressively moves the stent 114 along the length of the expansion mandrel 110. Only two blades A and B are depicted in this sequence for ease of explanation. Blade B is depicted in phantom lines to prevent confusion as to the positioning of these two blades. Each blade A and B of the expansion mandrel 110 is designed to move in a linked pattern which causes the mounted stent 114 to move axially along the mandrel 110. As can be seen in FIG. 16A, the stent 114 is initially in contact with the upper surface of blade A. Blade B is located in a position which is lower than blade A so that blade B is not in direct contact with the stent 114. FIG. 17 now shows movement of the blades A and B from the positions shown in FIG. 16A. As can be seen in FIG. 17, blade A moves slightly upward and to the right a bit while blade B has been moved to the left somewhat. The movement of blade A, in turn, causes the stent 114 to move to the right as well. When the full set of blades A contact the stent 114, as is shown in the end view of FIG. 16B, the stent is raised and expanded slightly and is moved to the right as the blades A move accordingly. FIG. 18 now shows the next sequence of movement in which blade A is lowered and is no longer in contact with stent 114. Blade B, however, has been moved in an upward fashion to now engage the stent 114. Blade B will now serve as the blade which further moves the stent 114 axially along the length of the expansion mandrel 110. In this sequence, blade B moves upward slightly to expand the diameter of the stent 114. As can be seen in FIG. 19, blade B has now moved to the right while blade A has been shifted to the left. Again, the movement of blade B to the right moves the stent 114 along the length of the mandrel 110 as is shown in FIG. 17. Finally, FIG. 20 shows the placement of blades A and B with respect to each other, as is shown in FIG. 16A, except now the position of the stent 114 has shifted to the right on the mandrel 110. In this progressive sequence of movement between blades A and B, the stent can be moved along the length of the mandrel to set the stent 114 to the desired expansion diameter.

It should be appreciated that a single blade A and single blade B could not move the stent 114 by themselves. For this reason, a set of blades A and a set of blades B are used to cooperatively contact the circular stent 114. An end view of the expansion mandrel 110 is shown in FIGS. 15 B and 16B. In usage, the set of blades A move in unison and set blade B move in unison as well. While only two blades A and B are depicted in these drawings, it should be appreciated that additional sets of blades could be incorporated with the set of blades, if desired. The series of progressive motion between additional sets of blades could be then be coordinated to create an appropriate “walking beam.”

The sets of blades can be connected to an actuating motor which is adapted to move each blade of the particular blade in the progressive movement depicted in the drawings. In this fashion, an automated walking beam can be used to expand the stent to a desired shape and diameter. As with the other disclosed embodiments, the expansion mandrel 110 can have a desired number of expansion regions and tapered regions.

It is to be recognized that number of expansion blades that can be incorporated to form an expandable mandrel described above can be varied and accordingly such blades can be spaced optimally about the mandrel. Additionally, different spacing of the blades relative to each other could also be achieved without departing from the spirit and scope of the present invention. The number of tapered regions and expansion regions of any of the described mandrels could also be varied, as desired, to obtain the desired final diameter of the stent. In this regard, the expansion mandrels can be made with numerous expansion regions. The operator only needs to advance the stent to the desired expansion region to achieve the desired diameter for the stent. If a larger diameter is needed, the operator has the ability to take the stent up to the next expansion region to obtain that diameter. Additionally, the expansion regions and tapered regions of the described mandrels have been shown having substantially uniform lengths. It should be appreciated that the length of the expansions regions could be much larger, especially when a longer stent is being processed. Long stents are used, for example, to treat Peripheral Artery Disease (PAD). Such stent are often implanted in the arteries of the legs where longer stents are needed.

The individual blades which make up the expandable mandrel can be made from suitable materials such as metals, including, but limited to stainless steel, and possible hard polymeric materials and ceramics. The blade holder could be made from similar materials.

While the present invention has been described in conjunction with a self-expanding stent, a balloon expandable stent having any configuration or pattern could also be made using the apparatus and methods described herein. The stent body can comprise metal, metal alloy, or polymeric material. Some exemplary materials include Nitinol and stainless steel. Other complimentary materials include cobalt chromium alloy, ceramics and composites abd organic and polymeric materials.

While the present invention is described herein in terms of certain preferred embodiments, those skilled in the art will recognize that various modifications and improvements may be made to the invention without departing from the scope thereof. Moreover, although individual features of one embodiment of the invention may be discussed herein or shown in the drawings of the one embodiment and not in other embodiments, it should be apparent that individual features of one embodiment may be combined with one or more features of another embodiment or features from a plurality of embodiments.

In addition to the specific embodiments claimed below, the invention is also directed to other embodiments having any other possible combination of the dependent features claimed below and those disclosed above. As such, the particular features presented in the dependent claims and disclosed above can be combined with each other in other manners within the scope of the invention such that the invention should be recognized as also specifically directed to other embodiments having any other possible combinations. Thus, the foregoing description of specific embodiments of the invention has been presented for purposes of illustration and description. It is not intended to be exhaustive or to limit the invention to those embodiments disclosed.

Many modifications, variations, or other equivalents to the specific embodiments described above will be apparent to those familiar with the art. It is intended that the scope of this invention be defined by the claims below and those modifications, variations and equivalents apparent to practitioners familiar with this art. While the specification describes particular embodiments of the present invention, those of ordinary skill can devise variations of the present invention without departing from the inventive concept. Accordingly, it is not intended that the invention be limited, except as by the appended claims.

We claim:

1. A method of manufacturing a medical device comprising:
forming a tubular stent having an internal lumen, a proximal end, a distal end and a longitudinal axis extending therebetween, the stent having a generally cylindrical shape defining a first stent diameter;
placing the stent over a braided sleeve, the braided sleeve having an internal lumen, a proximal end, a distal end and a longitudinal axis therebetween;
inserting a mandrel into the internal lumen of the braided sleeve, at least a portion of the mandrel having a diameter that is greater than the first stent diameter;
wherein insertion of the mandrel into the braided sleeve radially expands the stent to a second stent diameter, the second stent diameter being greater than the first stent diameter.

2. The method of claim 1, wherein the mandrel has a first portion and a second portion, the second portion having a diameter larger than the first portion, the second portion having a diameter larger than the first stent diameter, and the method includes sliding the stent and the braided sleeve from the first portion of the mandrel to the second portion of the mandrel.

3. The method of claim 1, wherein the braided sleeve is made from stainless steel.

4. The method of claim 1, wherein the braided sleeve is made from quartz or fused glass.

5. The method of claim 1, wherein the braided sleeve is made from a high temperature material.

6. The method of claim 2, wherein the braided sleeve expands with the stent as it moves from the first portion of the mandrel to the second portion of the mandrel.

7. The method of claim 1, further including a portion located between the first portion and the second portion of the mandrel which extends from the first diameter of the first portion to the larger diameter of the second portion.

8. The method of claim 2, further comprising exposing the stent to a controlled temperature zone when the stent is being slide from the first portion to the second portion of the mandrel.

9. The method of claim 8 wherein the controlled temperature zone is at a temperature which places the stent in the martensitic phase.

10. The method of claim 9, further comprising exposing the stent to a temperature within the range of approximately 175 and 600 degrees Fahrenheit.

11. An expansion mandrel for expanding the diameter of a stent, comprising:
a plurality of expansion blades which cooperatively form the expansion mandrel, each expansion blade having a longitudinal length which terminates at a proximal end and a distal end, each expansion blade being movable longitudinally with respect to each other, each expansion blade having a first expansion region and a second expansion region, the first expansion region having a first height and the second expansion region having a second height which is greater than the first height of the first expansion region, the plurality of expansion blades cooperatively forming an external surface at the first expansion region defining a generally cylindrical configuration and the plurality of expansion blades cooperatively forming an external surface at the second expansion region defining a generally cylindrical configuration.

12. An expansion mandrel for expanding the diameter of a stent, comprising:
a first subset of one or more longitudinally movable expansion blades; and
a second subset of one or more longitudinally movable expansion blades, wherein each expansion blade of each of the first and second subset has a proximal end, a distal end and a longitudinal axis extending therebetween, each expansion blade having a first expansion region and a second expansion region, the first expansion region having a first height and the second expansion region having a second height which is greater than the first height of the first expansion region, the expansion blades of the first subset and second subset cooperatively forming an external surface at the first expansion region defining a generally cylindrical configuration and the plurality of expansion blades cooperatively forming an external surface at the second expansion region defining a generally cylindrical configuration, the expansion blades of the first subset being movable together and the expansion blades of the second subset being movable together.

13. An expansion mandrel for expanding the diameter of a stent, comprising:
at least two subsets of longitudinally movable expansion blades, each expansion blade of each of the subsets having a proximal end, a distal end and a longitudinal axis extending therebetween, each expansion blade having a first region and a second region, the first region of each expandable blade of the subsets cooperatively forming a generally cylindrical configuration having a first diameter and the second region of each expandable blade of the subsets cooperatively forming a generally cylindrical configuration having a second diameter, the second diameter being larger that the first diameter, wherein the expandable blades of each subset are movable together along the longitudinal axis.

14. An expansion mandrel for expanding the diameter of a stent, comprising:
three subsets of longitudinally movable expansion blades, each expansion blade of each of the subsets having a proximal end, a distal end and a longitudinal axis extending therebetween, each expansion blade having a first region and a second region, the first region of each expandable blade of the subsets cooperatively forming a generally cylindrical configuration having a first diameter and the second region of each expandable blade of the subsets cooperatively forming a generally cylindrical configuration having a second diameter, the second diameter being larger that the first diameter, wherein the expandable blades of each subset are movable together along the longitudinal axis.

15. A method for expanding the diameter of a stent using an expandable mandrel, comprising:
providing an expandable mandrel having a plurality of expansion blades which cooperatively form the expansion mandrel, each expansion blade having a longitudinal length which terminates at a proximal end and a distal end, each expansion blade being movable longitudinally with respect to each other, each expansion blade having a first expansion region and a second expansion region, the first expansion region having a first height and the second expansion region having a second height which is greater than the first height of the first expansion region, the plurality of expansion blades cooperatively forming an external surface at the first expansion region defining a generally cylindrical configuration and the plurality of expansion blades cooperatively forming an external surface at the second expansion region defining a generally cylindrical configuration;
sliding at least one stent onto the first expansion region;
moving at least one expansion blade relative to an adjacent expansion blade;
sliding the at least one stent to the second expansion region.

16. The method of claim 15, further including exposing the at least one stent and expansion mandrel to a controlled temperature zone when the at least one stent is being slid along the expansion mandrel.

17. The method of claim 16, further including moving at least an additional expandable blade simultaneously with the first-mentioned expansion blade relative to the remaining blades forming the expandable mandrel.

18. The method of claim 17, further including exposing the at least one stent and expansion mandrel to a controlled temperature zone when the at least one stent is being slid along the expansion mandrel.

19. The method of claim 16, wherein the expandable mandrel includes a tapered region between the first expansion region and the second expansion region.

20. The method of claim 16, wherein each expansion blade is slidable housed within a blade holder.

21. The expansion mandrel of claim 12 further including a first set of expansion blades that are fixed relative to the first subset of movable expansion blades.

22. The expansion mandrel of claim 21 further including a second set of expansion blades that are fixed relative to the second subset of movable expansion blades.

23. An expansion mandrel for expanding the diameter of a stent, comprising:
a first subset of one or more longitudinally movable expansion blades; and
a second subset of one or more longitudinally movable expansion blades, wherein each expansion blade of each of the first and second subset has a proximal end, a distal end and a longitudinal axis extending therebetween, each expansion blade having a first expansion region and a second expansion region, the first expansion region having a first height and the second expansion region having a second height which is greater than the first height of the first expansion region, the expansion blades of the first subset and second subset cooperatively forming an external surface at the first expansion region and the plurality of expansion blades cooperatively forming an external surface at the second expansion region, the expansion blades of the first subset being movable together in an (1) initial upward position to lift and expand the diameter of a deposited stent away from contact with the expansion blades of the second subset and a (2) linear motion towards the second expansion region of expansion blades of the second subset which moves the raised and expanded stent into contact with the expansion blades of the second subset, the expansion blades of the second subset also being movable together in an (1) initial upward position to lift the expanded stent away from contact with the expansion blades of the first subset to further expand the diameter of the stent and a (2) linear motion towards the second expansion region of the expansion blades of first subset which moves the raised and expanded stent into contact with the expansion blades of the first subset.

24. The expansion mandrel of claim 23 further including an actuating motor coupled to the first and second subsets of expansion blades to move the first set of expansion blades and second subset of expansion blade through their range of motion defined in (1) and (2).

25. The expansion mandrel of claim 24 further including a third set of expansion blades that are associated with the first and second subset of expansion blades and are adapted to be raised to an upward position to lift the expanded stent away from contact with the expansion blades of the first and second subsets to further expand the diameter of the stent and a (2) linear motion towards the second expansion region of the expansion blades of first and second subsets which moves the raised and expanded stent into contact with the expansion blades of the first and second subsets.
